(19) United States
(12) Patent Application Publication
(10) Pub. No.: US 2018/0301846 A1
(43) Pub. Date: Oct. 18, 2018

(54) PLUG CONNECTOR

(71) Applicant: HARTING ELECTRONICS GMBH, Espelkamp (DE)

(72) Inventor: Marc Lindkamp, Luebbecke (DE)

(21) Appl. No.: 15/779,463

(22) PCT Filed: Jan. 6, 2017
(86) PCT No.: PCT/DE2017/100009

§ 371 Date: May 25, 2018

(30) Foreign Application Priority Data
Jan. 12, 2016 (DE) 10 2016 100 382.4

(51) Int. Cl. H01R 13/627; H01R 13/639; H01R 24/64

(52) U.S. Cl. CPC H01R 13/6272; H01R 2107/00; H01R 24/64; H01R 13/6397

(57) ABSTRACT

A plug connector has a housing with a plug side and a cable connection side. At least one latching element is arranged on the housing of the plug connector. The at least one latching element can be moved between a first locking position and a second unlocking position. The at least one latching element has openings and insertion bevels. The openings and the insertion bevels allow an automatic latching to a mating plug connector. It is only possible to interrupt the contact of the plug connector using an aid. In this manner, protection is provided against an unauthorized interruption of the contact, and a desired interruption of the contact is made possible without special tools.

The invention is based on a plug connector as claimed in the preamble of independent claim 1.

Plug connectors of this kind are used for connections for data transmission and/or telecommunication and/or network technology.

The known plug connectors have a locking arrangement in the form of a snap-action locking arrangement for making contact and breaking contact. This locking arrangement comprises a lug with which the plug connector is locked when contact is made by a corresponding mating plug connector. Contact with the plug connector is broken again by pushing the lug down. Owing to the snap-action locking arrangement, the plug connector can be easily connected and released, but there is no protection against unauthorized contact-making and/or contact-breaking operations.

U.S. Pat. No. 7,695,303 B2 discloses a plug connector for telecommunication and data transfer with a securing means. The securing means serves to protect against unauthorized contact with the plug connector being made and broken. The securing means of the plug connector can be released only by means of a special key.

An electrical plug connector arrangement with a mutual latching spring is known from DE 29 09 616 A1. This corresponds to a corresponding recess in the housing wall of the mating plug device, into which recess the latching spring can engage and in this way latches the plug device to the mating plug device.

However, the known plug connectors have the disadvantage that they either provide absolutely no protection against unauthorized contact-making and/or contact-breaking operations or, if protection is provided, such as in U.S. Pat. No. 7,695,303 B2 for example, a special tool, which can be used only for this plug connector, is required for releasing the plug connector.

### OBJECT

The object of the invention is to provide a plug connector which has a securing means. This securing means is intended to prevent contact with the plug connector being broken or said plug connector being released in an unauthorized or accidental manner. Furthermore, an intentional contact-breaking operation should still be possible.

The object is achieved by the characterizing features of independent claim 1.

Advantageous refinements of the invention are specified in the dependent claims.

The present invention relates to a plug connector which has a housing. The housing has, for its part, a plug side and a cable connection side. The plug side and the cable connection side are arranged opposite one another. This means that the plug side is arranged at one end of the housing and the cable connection side is arranged at an end of the housing which is situated opposite the end of the plug side.

The plug side has one or more contacts which are arranged parallel in relation to one another. This one contact or the plurality of contacts serve the purpose of establishing one or more electrical connections. The connection is established by a mating plug connector making contact with the plug connector on the plug side.

An electrical cable can be connected to the cable connection side and can be inserted into the plug connector. The electrical conductors of the cable can be connected to the contacts on the plug side in the interior of the plug connector.

At least one latching element is arranged on the housing of the plug connector. The latching element is preferably arranged to the side in relation to the plug side.

According to the invention, the at least one latching element can be moved between a first, locked position and a second, unlocked position. The first, locked position corresponds to a static position of the at least one latching element before a contact-making operation and in the case of an existing contact-connection with a mating plug connector. The second, unlocked position corresponds to a dynamic position of the at least one latching element during a contact-making process and during a contact-breaking process. Wherein the at least one latching element can be automatically moved to the second, unlocked position during the contact-making process. Contact-making relates both to an electrical connection being established and also to the mechanical latching between plug connector and mating plug connector.

The at least one latching element can be moved between the two positions and is arranged on the housing with a spring action. The spring-action arrangement is designed such that the at least one latching element is forced into the first, locking position.

In a special embodiment, the at least one latching element is integrally formed on the housing. Owing to an advantageous spring effect of the material, the at least one latching element can be moved between the first, locked position and the second, unlocked position.

In a preferred embodiment, the at least one latching element is formed from two spring arms. In each case, one end of the spring arm is connected to the housing. A further end of the spring arm is in the form of a free end with a spring action. The free ends of the at least one latching element are arranged closer to one another in the second, unlocked position than in the first, locked position.

Furthermore, the at least one latching element has two insertion bevels. The at least one latching element can be moved to the second, unlocked position by these insertion bevels. An insertion bevel is respectively integrally formed at a free end of the spring arms of the at least one latching element. The insertion bevels are provided on the spring arms such that, when the plug connector is inserted into a mating plug connector, said mating plug connector acts on the insertion bevels such that the spring arms move toward one another.

In a further embodiment, the at least one latching element has two openings—one on each spring arm. The openings are preferably provided in the region of that end of the spring arm which is fastened to the housing. The at least one latching element can be manually moved between the first, locked position and the second, unlocked position by means of these two openings.

For the purpose of manual operation, it is provided to move the at least one latching element between the first, locked position and the second, unlocked position by means of a tool. The tool is preferably a standardized, commercially available tool. Needle-nose pliers or other tools with which it is possible to reach into the openings on the two spring arms can expediently be used here. The spring arms of the latching element are moved toward one another, into the unlocked position, by pushing together the two openings toward one another.

In a preferred embodiment, the plug connector is an RJ45 plug connector.

The present invention solves the object according to the invention by a plug connector being formed with a latching element as securing means. The latching element provides protection against unauthorized release of the plug connector and contact with the plug connector being broken. Furthermore, the plug connector allows contact to be intentionally broken without special tools.

### EXEMPLARY EMBODIMENT

An exemplary embodiment of the invention is illustrated in the drawings and will be explained in greater detail below. In the drawings:

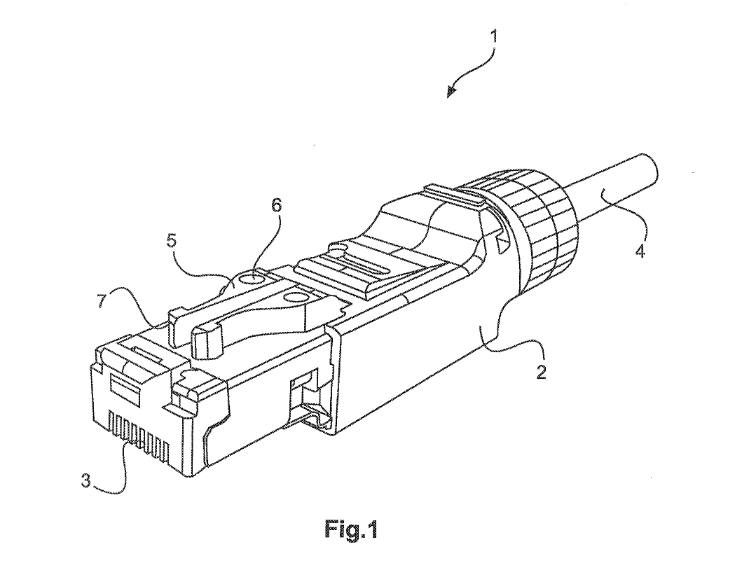

FIG. 1 shows a perspective illustration of a plug connector according to the invention.

The figures contain partially simplified, schematic illustrations. To some extent, identical reference symbols are used for the same but possibly not identical elements. Various views of the same elements could be scaled differently.

FIG. 1 shows a perspective view of an RJ45 plug connector 1 according to the invention. The plug connector 1 has a main body and a housing 2 with a plug side and a cable connection side. The plug side and the cable connection side are situated opposite one another.

The main body is accommodated in regions in the housing 2 from the plug side. A plurality of contacts 3 which are arranged parallel in relation to one another are accommodated in the main body.

An electrical cable 4 is connected to the cable connection side and guided into the plug connector 1.

A latching element is integrally formed on the housing 2 of the plug connector 1. Said latching element is arranged on the housing 2 to the side in relation to the main body and with a spring action. The latching element can be moved between a first, locked position and a second, unlocked position.

In the illustrated exemplary embodiment, the at least one latching element is formed from two spring arms 5. In each case, one end of the spring arm 5 is connected to the housing 2. A further end of the spring arm 5 is in the form of a free end with a spring action.

Insertion bevels 7 are respectively integrally formed on the free ends of the spring arms 5. The insertion bevels 7 are provided on the spring arms 5 such that, when the plug connector 1 is inserted into a mating plug connector, said mating plug connector acts on the insertion bevels 7 such that the spring arms 5 move toward one another.

Furthermore, the fixed ends of the spring arms 5 have two openings 6, one opening 6 for each spring arm 5 in each case. The at least one latching element can be manually moved between the first, locked position and the second, unlocked position by means of these two openings 6.

In FIG. 1, the free ends of the spring arms 5 point in the direction of the main body and are in the first, locked position. The free ends of the spring arms 5 are arranged closer to one another in the second, unlocked position.

Therefore, the first, locked position describes the state of the at least one latching element when the plug connector 1 either has not yet formed a connection with a mating plug connector, as shown in FIG. 1, or is not yet completely latched to a mating plug connector at all.

The at least one latching element is in the second, unlocked position during the contact-making or contact-breaking process with a mating plug connector,

For the purpose of breaking contact, an aid is used in order to move the free ends of the spring arms 5 from the first, locked position to the second, unlocked position. This aid is inserted into the openings 6.

Said aid is, for example, a tool which opens when it is pushed together. As an alternative, the aid may also be expanding pliers or circlip pliers. As a result, contact with the RJ45 plug connector 1 can be broken and said RJ45 plug connector can be released without using a specially manufactured or shaped aid.

### Plug Connector

### LIST OF REFERENCE SYMBOLS

1 Plug connector

2 Housing

3 Contact

4 Electrical cable

5 Spring arm

6 Opening

7 Insertion bevel

1. A plug connector having a main body and a housing with a plug side and a cable connection side,
wherein the plug side and the cable connection side are arranged opposite one another, wherein one or more contacts, which are arranged parallel in relation to one another, are accommodated in the main body for the purpose of establishing one or more electrical connections,
wherein an electrical cable can be connected to the cable connection side,
wherein at least one latching element is arranged on the housing,
wherein the at least one latching element is arranged to the side in relation to the main body,
wherein the at least one latching element can be moved between a first, locking position and a second, unlocking position, and
wherein
the at least one latching element is integrally formed on the housing,
in that the at least one latching element is formed from two spring arms (5), wherein one end of the spring arm is connected to the housing and a further end of the spring arm is in the form of a free end with a spring action, and
the at least one latching element has two openings in the region of that end of the spring arm which is fastened to the housing.

2. The plug connector as claimed in claim 1,
wherein
the at least one latching element is arranged on the housing with a spring action, and the at least one latching element is forced into the first, locked position.

3. The plug connector as claimed in claim 1,
wherein
the free ends of the spring arms of the at least one latching element are arranged closer to one another in the second, unlocked position than in the first, locked position.

4. The plug connector as claimed in claim 1,
wherein
the at least one latching element has two insertion bevels via which the at least one latching element can be moved to the second, unlocked position.

5. The plug connector as claimed in claim 4,
wherein
an insertion bevel is integrally formed at a respective free end of the spring arms in each case.

6. The plug connector as claimed in claim 1,
wherein
the at least one latching element can be moved from the first, locked position to the second, unlocked position by a tool.

7. The plug connector as claimed in claim 1,
wherein
the plug connector is an RJ45 plug connector.

8. The plug connector as claimed in claim 2,
wherein
the free ends of the spring arms of the at least one latching element are arranged closer to one another in the second, unlocked position than in the first, locked position.

9. The plug connector as claimed in claim 2,
wherein
the at least one latching element has two insertion bevels via which the at least one latching element can be moved to the second, unlocked position.

10. The plug connector as claimed in claim 3,
wherein
the at least one latching element has two insertion bevels via which the at least one latching element can be moved to the second, unlocked position.

11. The plug connector as claimed in claim 9,
wherein
an insertion bevel is integrally formed at a respective free end of the spring arms in each case.

12. The plug connector as claimed in claim 10,
wherein
an insertion bevel is integrally formed at a respective free end of the spring arms in each case.

13. The plug connector as claimed in claim 2,
wherein
the at least one latching element can be moved from the first, locked position to the second, unlocked position by a tool.

14. The plug connector as claimed in claim 3,
wherein
the at least one latching element can be moved from the first, locked position to the second, unlocked position by a tool.

15. The plug connector as claimed in claim 4,
wherein
the at least one latching element can be moved from the first, locked position to the second, unlocked position by a tool.

16. The plug connector as claimed in claim 5,
wherein
the at least one latching element can be moved from the first, locked position to the second, unlocked position by a tool.
